(19) United States
(12) Patent Application Publication
(10) Pub. No.: US 2012/0072370 A1
(43) Pub. Date: Mar. 22, 2012

(54) Financial instrument

(76) Inventors: Matthew Marcus, Winnetka, CA (US); Mitchell Marcus, (US)

(21) Appl. No.: 12/924,113

(22) Filed: Sep. 20, 2010

(51) Int. Cl. G06Q 40/00

(52) U.S. Cl. 705/36 R; 705/37

(57) ABSTRACT

In accordance with the principles of the present invention, a financial instrument and method is provided. At least two open-ended funds having settlement prices are identified. An index value is created relating to the settlement prices of the at least two open-ended funds. A weighting factor is assigned to the at least two open-ended funds. A components value is determined based on the settlement price and weighting factor. A fund manager futures index is derived based on the component values. A financial instrument is based on the fund manager index. In an additional embodiment, an exchange-traded fund is offered whose value substantially tracks the fund manager index value.

### FIELD OF THE INVENTION

The present invention relates to financial instruments.

### BACKGROUND OF THE INVENTION

At one time, there were only open-outcry exchanges where brokers and traders, or more specifically buyers and sellers, would come together to trade in person. Merchants offering commodities for sale brought samples to the exchange, and buyers would come to the exchange to examine the quality of the offered merchandise. Today there is no merchandise to examine and the most liquid futures contracts are intangible financial instruments used for example for hedging financial risk.

Hedging can be defined as the purchase or sale of a security or derivative (such as options or futures and the like) in order to reduce or neutralize all or some portion of the risk of holding another security or other underlying asset. Hedging equities is an investment approach that can alter the payoff profile of an equity investment through the purchase and/or sale of options or other derivatives. Hedged equities are usually structured in ways that mitigate the downside risk of an equity position, albeit at the cost of some of the upside potential.

The most popular (commodity) futures contracts in the world are known as financial futures products and are traded electronically or in the pit of futures exchanges. Examples include the S&P 500, T-Bond, Fed Funds Futures, Single Stock futures on Google, and Eurodollar to name a few. By and large financial futures trade trillions of dollars in gross annual volume and far exceed the daily volume of any tangible asset based futures (with the exception of crude oil) by exorbitant amounts facilitating liquidity for the global economic structure. Single stock futures or futures trading on stocks like Yahoo are now offered through the electronic exchange OneChicago, Chicago, Ill. 60604.

Generally speaking, a futures contract is an agreement to purchase or sell a commodity for delivery in the future at a price that is determined at initiation of the contract; that obligates each party to the contract to fulfill the contract at the specified price; that is used to assume or shift price risk; and that may be satisfied by delivery or offset. Futures contracts are most often liquidated prior to the delivery date and are generally used as a financial risk management tool rather than for supply purposes. These contracts are traded on regulated exchanges and are settled daily based on their current value in the marketplace.

A contract's final settlement (that is, settlement after expiration of the futures contract) can be the cash settlement type or the delivery settlement type. But, even in the case of delivery-settlement type futures contracts, very few settlements actually result in delivery. The settlement price is an amount that an exchange treats as a value, usually established by an exchange settlement committee at the close of each trading session for each futures contract for each commodity for delivery at a particular time in the future. The settlement price is used by the clearinghouse in determining net gains or losses, margin requirements, and the next day's price limits.

The close in futures trading refers to a brief period at the end of the day, during which transactions frequently take place quickly and at a range of prices immediately before the closing bell. Although the term “settlement price” is used as an approximate equivalent to the term “closing price,” a settlement price is not any particular transaction price (that is, the price of a particular trade). In contract months with significant trading volume in the closing range, the settlement price can be derived by calculating the weighted average of the prices at which trades were conducted during the closing range. For months that have little to no volume during the closing range, trade data can be used together with other factors the exchange believes should be taken into account.

Futures contracts are standardized to make sure that the prices mean the same thing to everyone in the market; everyone trades contracts with the same specifications for quality, quantity, and delivery terms. An advantage of standardization is that it reduces the number of variables that need to be negotiated before a trade can be executed. The specifications generally would include: the underlying asset—this can be for example anything from a barrel of light, sweet crude (crude oil futures for example) to a short term interest rate to pork bellies; the type of final settlement—either cash settlement or physical settlement (following the final termination of trading on the last day of a listed contract month) and, if physically delivered, the nature of the delivery procedures; the amount and units of the underlying asset per contract—this can be for example the notional amount of bonds, a fixed number of barrels of oil, units of foreign currency, the notional amount of the deposit over which the short term interest rate is traded; the currency in which the futures contract is quoted; the grade and quality specifications of the deliverable assets—for example in the case of bonds, this specifies which bonds can be delivered—in the case of physical fund managers, this specifies not only the quality of the underlying goods but also the manner and location of delivery; the delivery month; the last trading date; and other details such as for example the commodity trading tick size.

Traders can seek exposure to a given market or sector through the purchase of an index-based investment product. Such products are based on an index that tracks a certain market (for example, the NASDAQ Composite index) or sector (for example, the NASDAQ-100 technology index). One manner of achieving returns with an index product is by arbitrage. In short, in arbitrage a trader takes a buy or sell position in the index product and the opposite position in the index product's constituents. By taking advantage of market inefficiencies, arbitrage can achieve substantial returns.

Exchange-traded funds trade during exchange hours in a market transaction structure similar to most stocks where the exchange-traded funds is listed typically on a stock exchange such as AMEX or Nasdaq. Futures on exchange-traded funds are currently traded on the OneChicago Exchange. For example, DIAMONDS Futures are futures contracts on the DIAMONDS Exchange-traded fund (ETF), which represents ownership in the DIAMONDS Trust, Series 1. The DIAMONDS ETF tracks the Dow Jones Industrial Average (DJIA).

### SUMMARY OF THE INVENTION

In accordance with the principles of the present invention, a financial instrument and method is provided. At least two open-ended funds having settlement prices are identified. An index value is created relating to the settlement prices of the at least two open-ended funds. A weighting factor is assigned to the at least two open-ended funds. A components value is determined based on the settlement price and weighting factor. A fund manager futures index is derived based on the component values. A financial instrument is based on the fund manager index. In an additional embodiment, an exchange-traded fund is offered whose value substantially tracks the fund manager index value.

### BRIEF DESCRIPTION OF THE DRAWINGS

FIG. 1 is a schematic representation of a fund manager index.

FIG. 2 is a flow chart of an example of an overall methodology for arriving at the numerical value of the fund manager index

FIG. 3 is a flow chart of a method for generating the fund manager index value and a second method to yield the price of a futures contract of FIG. 2.

FIG. 4 is a table that depicts an example of a method for calculating of the component value in greater detail.

FIG. 5 is a flow chart of an example of a method for offering products based on a fund manager index.

FIG. 6 is a flow chart depicting exemplary methods of arbitrage.

FIG. 7 is a non-limiting example of a high level hardware that can used to implement the present invention.

### DETAILED DESCRIPTION OF AN EMBODIMENT

In accordance with the principles of the present invention, financial instruments and methods are provided based on the investment return of open-ended fund manager's funds such as for example mutual funds, hedge funds, and other fund manager's funds or an index of fund managers. In accordance with the principles of the present invention, financial instruments and methods are provided that are based on a fund manager futures index. The fund manager futures index has a numerical value that, in accordance with a method of the present invention, tracks the settlement prices of a predetermined group of fund manager's funds. Based on this fund manager index, a futures contract can be offered on a futures exchange. In further embodiments, options on the futures contract, an exchange-traded fund, and options on the exchange-traded fund can also be provided.

An open-ended fund is a collective investment which can issue and redeem shares at any time. An investor can purchase shares in such funds directly from a mutual fund company, or through a brokerage house once per day. Open end fund managers are subject to a daily settlement price. For most investment fund managers that are non exchange traded this occurs daily at a predetermined time by the fund manager or brokerage firm.

Fund manager futures may be offered by an exchange or directly by a fund family (for example, Fidelity Fund Futures available from Fidelity Investments, Boston, Mass.), hedge fund family (for example, George Soros Quantum Fund Futures available from Soros Fund Management, New York, N.Y.), commodities trading advisors or other asset manager indexes (for example, Barclays Commodity Trading Advisor Index available from Barclays Global Investors, San Francisco, Calif.). Furthermore, a plurality of fund futures (for example, Fidelity Futures+Quantum Hedge Fund Futures+Barclays CTA futures) can be incorporated into a futures fund based index, futures contract, option or exchange-traded fund investment product.

In one aspect of the present invention, a fund manager index can be created that represents the value of a preselected group of fund manager's futures contracts. Preferably, the group can consist of fewer than 10 fund managers, and more preferably, five or fewer fund managers. Several products can then be provided based on the fund manager index. A futures contract (and related options contracts) based on the fund manager index can be provided by a futures exchange. In addition, a commodity pool, in communication with a futures exchange, can offer an exchange-traded fund on a stock exchange based on the fund manager index. Options on the exchange-traded fund can be traded on a futures exchange. The advantage of this product and related methods is that it allows a trader to effectively arbitrage in the futures market with a fund manager index product.

Referring to FIG. 1, an exemplary composition of a fund manager index 101, and therefore, the composition of a futures contract based on the fund manager index is schematically depicted. As shown in this example, the fund manager index comprises a first fund 102, a second fund 103, and a third fund 104. In this example, the first fund, the second fund 103, and the third fund 104 can be provided in the ratios of 1:2:3; however, this ratio can vary in other examples (such as, for example, 1:1:1, 2:1:1, 4:1:3, 3:3:1, and other permutations thereof).

In this example, the settlement price of the third fund 104 effects the numerical value of fund manager index 101 three times as much as the first fund 102, and the settlement price of the second fund 103 affects the numerical value of fund manager index 101 two times as much as the first fund 102. In this example, 1:2:3 was chosen because, among other things, a simple ratio facilities arbitrage (discussed in more detail below).

The first fund 102 can represent for example a fund family such as for example the Fidelity Fund Futures. The second fund manager 103 can represent for example a hedge fund family such as for example the George Soros Quantum Fund Futures. The third fund manager 104 can represent for example a commodities trading advisors such as for example the Barclays Commodity Trading Advisor Index.

In other examples in accordance with the principals of the present invention, other fund managers can be included in the fund manager index 101. For example, a fourth fund could be added, resulting in a ratio of 1:1:2:3. The forth fund can represent for example a fund of funds such as for example Vanguard STAR available from the Vanguard Group, Valley Forge, Pa.

The fund manager index is based on the constituents of a spread, for example, the alpha (performance above or below a benchmark index) or beta (volatility versus a benchmark index) spread of correlated or non correlated fund manager futures or benchmark indexes.

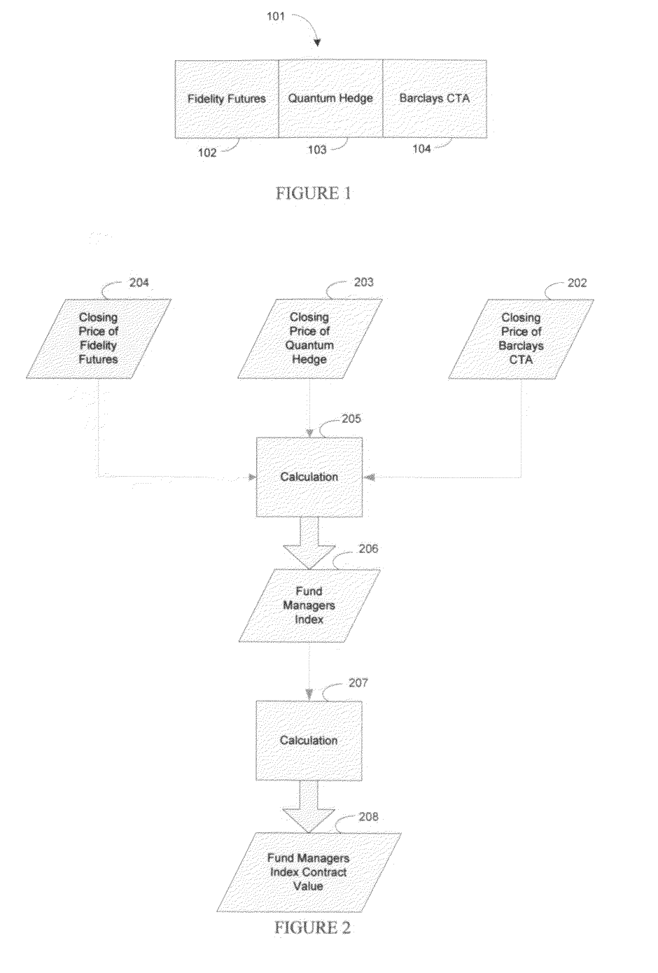

FIG. 2 depicts an example of an overall methodology for arriving at the numerical value of the fund manager index. The methodology utilizes the settlement prices of the underlying funds, such as for example the first fund 202, the second fund 203, and the third fund 204. The manner for traders to assess the market value of a futures contract during a trading session varies depending upon the nature of the fund. The price of a futures contract is generally determined by arbitrage analysis. Under arbitrage analysis, the futures price represents the expected future value of the underlying asset discounted at the risk free rate. Thus, for a simple, non-dividend paying asset, the value of the future, F(t), will be found by discounting the present value S(t) at time t to maturity T by the rate of risk-free return r:

F(t)=S(t)*(1+r)_{T-1}),

or, with continuous compounding:

F(t)=S(t)e_{r(T-t)}

This relationship may be modified for manager fees and expenses of the fund, dividends, dividend yields, and convenience yields. In a perfect market, the relationship between futures and spot prices depends only on the above variables; in practice, however, there are various market imperfections (for example, transaction costs, differential borrowing and lending rates, restrictions on short selling) that disrupt this relationship. Thus, the futures price in fact varies within arbitrage boundaries around the theoretical price. This relationship, however, is typical for stock index futures, Treasury bond futures and futures on physical commodities when they are in supply (for example, corn after the harvest).

In addition to the supply and demand of underlying investment fund exposure, fund managers futures are subject to investment company reputation risk. There may be substantial pricing differentiation between the investment fund manager index, the futures price, and the intrinsic value of its holdings, which may create viable arbitrage opportunities but for the illiquidity of the fund manager's investment structure.

Regardless of the manner of determining the futures contract pricing, the settlement prices are input into a first method 205 that generates the fund manager index value. The first method 205 that generates the fund manager index value weighs the settlement prices of the constituent funds. In this example, the fund manager index value 206 is processed by a second method 207 to yield the price of a futures contract based on the fund manager index value. To yield the price of a futures contract 208, the second method 207 applies a multiplier (or divisor) to the fund manager index value to yield a futures contract value 208 that can be traded. The fund manager index value 206 is the basis for several investment and financial risk management products, including an investment product that can be traded on a stock exchange.

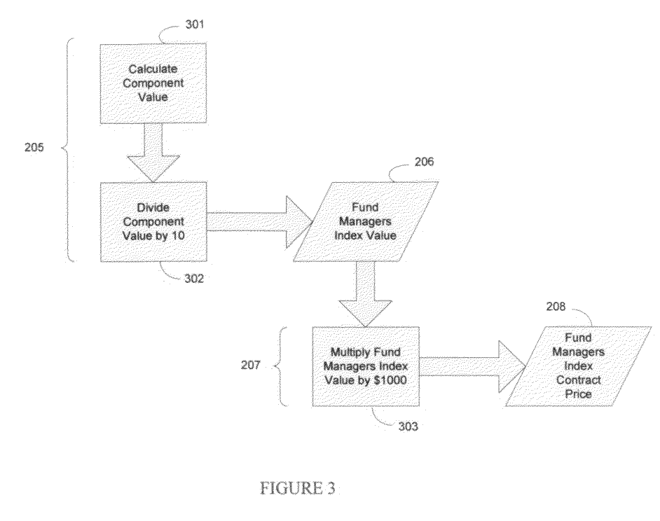

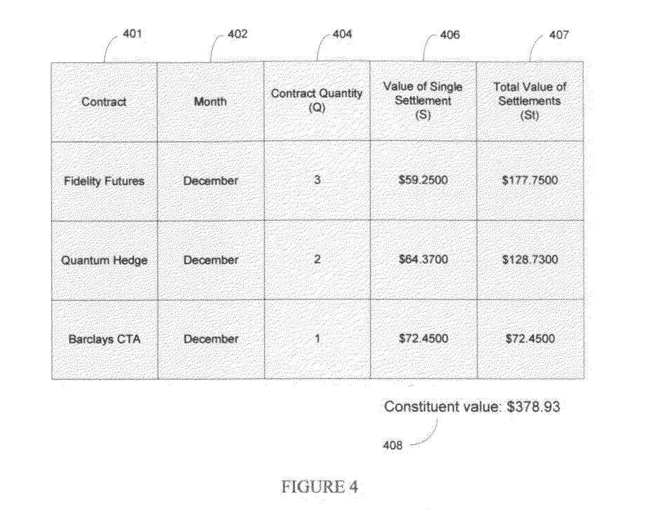

FIG. 3 depicts an example of the first method 205 that generates the fund manager index value and the second method 207 to yield the price of a futures contract of FIG. 2. In this example, the first method 205 that generates the fund manager index value can be derived by a calculation of the component value 301 and division of the component value 301 by, for example, ten 302. The component value 301 represents a weighted total of the value of the constituent funds. This process is discussed in detail with reference to FIG. 4. In this example, the fund manager index value 206 is the component value (calculated by process 301) divided by, for example, ten (process 302).

The second method 207 for deriving the fund manager index futures contract price includes multiplying the fund manager index value 206 by, for example, $1000 (by process 303). In other embodiments, the method 207 for deriving the fund manager index futures contract price 208 can multiply the fund manager index value 206 by a monetary factor other than $1000, depending on, for example, the constituent funds and the desired purchasers. For example, a financial risk management product geared toward individual traders can utilize a monetary factor lower than $1000 (for example, $10), whereas a product geared toward large institutional traders can use a larger monetary factor (for example, $25,000). Moreover, additional steps can be added to the method 207 for deriving the fund manager index futures contract price 208, including the addition of an up-front purchase fee (for example, a load, management fee or a convenience fee).

The pricing of the fund manager index futures contract does not itself necessarily conform to the models discussed above; instead, the price of the fund manager index futures contract can be calculated by one or more methods. The constituent funds, however, may be priced in accordance with an arbitrage and/or supply/demand model. Accordingly, the fund manager index futures price 208 (and fund manager index value 206) can be quickly and easily determined once the settlement prices of the constituent funds are determined. The first method 205 that generates the fund manager index value and the second method 207 to yield the price of a futures contract can be preferably executed by one or more programmed computers to achieve quick and convenient calculation of the fund manager index value 206 and fund manager index futures contract price 208. The fund manager index value 206 and fund manager index futures contract price 208 can be preferably determined at least each business day. More preferably, fund manager index value 206 and fund manager index futures contract price 208 can be determined each day soon after close of trading, thereby allowing daily settlement of the fund manager index futures contract.

FIG. 4 is a table that depicts an example of a method for calculating of the component value 301 in greater detail. Note that this example uses exemplary settlement prices 406 for the purpose of illustration. Actual implementations utilize daily settlement prices.

Each futures contract is identified by the underlying asset 401 (here, first fund 102 (Fidelity Fund Futures in this example), second fund 103 (George Soros Quantum Fund Futures in this example), and third fund 104 (Barclays Commodity Trading Advisor Index in this example)) and the contract month 402 (here, all are December contracts, for example). Each contract for the underlying assets 401 has a price 403 associated with a particular amount of the underlying asset. In this example, here, first fund 102 (Fidelity Fund Futures in this example) is priced at $59.2500, second fund 103 (George Soros Quantum Fund Futures in this example) is priced at $64.3700, and third fund 104 (Barclays Commodity Trading Advisor Index in this example) is priced at $72.4500.

Field 404 identifies, on a relative basis, how much of each contract is represented by the fund manager index value. In this example, there are three first fund 102 (Fidelity Fund Futures in this example) contracts to 2 second fund 103 (George Soros Quantum Fund Futures in this example) contracts to 1 third fund 104 (Barclays Commodity Trading Advisor Index in this example) contract. This yields the relative amount of each fund manager in the index.

The value of each settlement 406 is multiplied by the contract quantity 404 to yield the total value of settlements for each contract 407. The total value of settlements (Sₜ) for each contract 407 is determined as follows:

Sₜ=Q*S

where Q represents the contract quantity 404, and S represents the price of a single settlement 403.

The component value 408 (that is, the value calculated at step 301 in FIG. 3) is calculated by totaling the total value of settlements for each contract. The component value (CV) is determined as follows:

CV=Sₜ(CL)+Sₜ (RB)+Sₜ (HO)

Using these exemplary settlement prices 406, the constituent value 408 would be $378.93. Turning back to the example described in FIG. 3, upon dividing the component value by ten (step 302), a fund manager index value of 37.8930 is obtained. This value multiplied by $1000 (step 303) results in the fund manager index futures contract price (208) of $37,893. In this example, a trader who holds ten fund manager index futures contracts versus three first fund 102 (Fidelity Fund Futures in this example) contracts, two second fund 103 (George Soros Quantum Fund Futures in this example) contracts, and one third fund 104 (Barclays Commodity Trading Advisor Index in this example) contract will have a financially square position or a neutral position from a risk perspective. Put another way, purchase commitments are offset by sell commitments.

It is preferred that the component value 408, fund manager index value 206, and fund manager index futures contract price 208 be recalculated at least on a daily basis after the settlement prices 406 have been determined. It is also preferred that the minimum tick of the fund manager index futures contract price be $10, although other ticks are possible, such as $5, $50, $100, etc. Note, of course, that all formulae may vary to account for the addition of other fund manager contracts into the index.

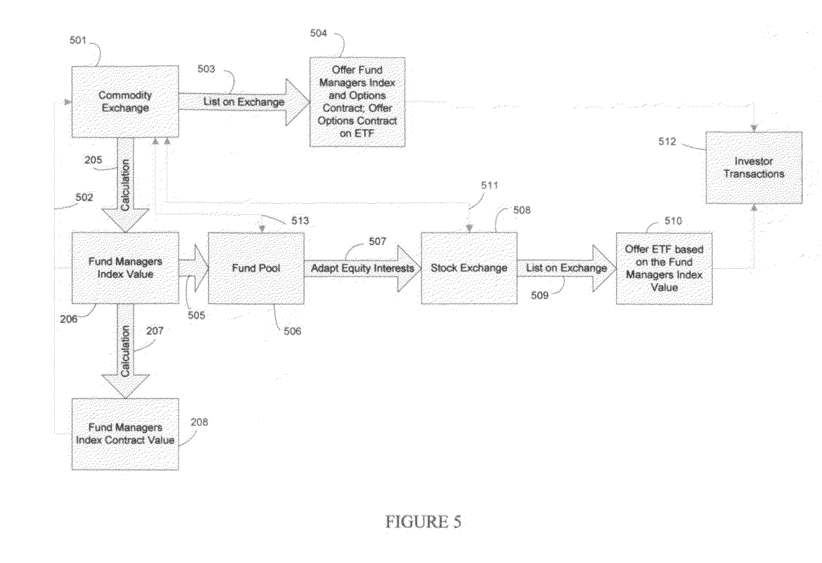

FIG. 5 illustrates an example of a method for offering products based on a fund manager index. As discussed, a futures exchange 501 (for example, the New York Mercantile Exchange) can utilize a method 205 that generates the fund manager index value 206 based on the settlement prices of a preselected group of funds. Another method 207 to yield the price of a futures contract 208 is applied to the fund manager index value 206 to yield the fund manager index futures contract value 208. The fund manager index value 206 and the fund manager index futures contract value 208 can be generated and communicated 502 within the futures exchange for purposes such as initially listing the fund manager index futures contract, publishing updated settlement prices of the fund manager index futures contract 208, and publishing updated fund manager index values 206. Communication 502 can be implemented by way of a computer network within the futures exchange 501, via the Internet or the fund manager index value 206 and the fund manager index futures contract value 208 could be manually communicated as needed.

Before any products relating to the fund manager index can be offered for sale to the public, they must first be listed on the futures exchange 503. For implementations subject to United States regulatory agencies, step 503 can include receiving approval from the Commodity Futures Trading Commission (CFTC) should a futures exchange voluntarily determine to seek prior approval rather than utilize the other rule submission approach noted below. The CFTC reviews the terms and conditions of proposed contracts (such as the fund manager index futures contract), and oversees registration of firms and individuals who either handle customer funds, give trading advice or engage in direct trading on the floor of a futures exchange. The Commodity Futures Modernization Act of 2000 gave exchanges the flexibility to “self certify” new futures contracts, options contracts on futures contracts and new rules, and rules amendments without prior CFTC approval, although the contracts or rules as applicable must still be submitted to the CFTC before they are launched, and the CFTC has final oversight. Step 503 can include steps that can be taken to maintain listings, for example, continuing regulatory compliance.

Once the products have been (and continue to be) listed 503, the exchange 501 may offer products (step 504) to the public based on the fund manager index value 206. These products can be based on the fund manager index value 206 and can include a cash-settled futures contract (priced as per item 208) and an options contract on the futures contract.

There are two types of options contracts that can be offered: “calls” and “puts.” A call gives the holder of the options contract the right, but not the obligation to buy the underlying fund manager index futures contract. Conversely, a put gives the holder the right, but not the obligation to sell the underlying fund manager index futures contract. The price at which the underlying fund manager index futures contract may be bought or sold is called the strike price. An options contract affords the right to buy or sell for only a limited period of time; each options contract has an expiration date. On the opposite side, a seller, or writer of an options contract incurs an obligation to perform, should an options contract be exercised by the purchaser. The writer of a call incurs an obligation to sell the fund manager index futures contract and the writer of a put has an obligation to buy the fund manager index futures contract.

In return for the rights granted, an options buyer pays an options seller a premium. Generally, the major factors affecting the price of the options contract include: the price of the fund manager index futures contract relative to the options strike price; the time remaining before options expiration; the volatility of underlying fund manager index futures price; and interest rates.

An options contract is a wasting asset. An options contract has an initial value that declines, or wastes away, as time passes. Depending upon the movement of the options price, the options buyer will choose one of three alternatives for terminating an options position: exercise the options contract, liquidate the options contract by selling it back on the futures exchange or let the options contract expire. While liquidation is the most common choice, a small percentage of buyers choose to exercise their options, particularly if their strategy calls for acquiring a long or short futures position at the strike price. If the fund manager index futures price does not move far enough for an exercise to be worthwhile, or moves in the opposite direction, buyers can simply let their options contract expire.

Also, the futures exchange 501 can offer an options contract on an exchange-traded fund listed on a stock exchange 508. The discussion above of options contracts on the fund manager index futures contract applies to this as well. The value of the exchange-traded fund can be based on the fund manager index value 206. In this example, a fund manager pool 506 can be established with a pool operator. For implementations subject to United States regulatory agencies, the pool operator can be a fund manager pool operator (CPO) registered under the Commodity Exchange Act. The fund manager pool 506 can be organized as a limited liability entity. In order to track the performance of the fund manager index value 206, the fund manager pool 506 invests (via communications 513 with the futures exchange 501) in the fund manager's future contracts that make up the fund manager index (that is, constituents 102, 103 and 104 of FIG. 1) in the proportion that they are represented in the index 101. To monitor tracking error, the fund manager pool 506 receives via a communication 505 (for example, a network communication via the Internet) the fund manager index value 206 on a periodic basis.

To make the exchange-traded fund available for purchase on the public stock exchange 508, equity interests in the fund manager pool 506 must be adapted via step 507 for public trading on the stock exchange 508. In implementations subject to United States regulations, equity interests in fund manager pool 506 can be registered under the Securities Act of 1933 via Form S-1. Upon completing regulatory requirements, the exchange-traded fund shares (that is, individual equity interests in the fund manager pool 506) can be listed on the stock exchange 509 and offered publicly to traders 510. The price of the exchange-traded fund shares can be priced intraday, providing price transparency to traders and the market. In some implementations, a fee may be built into the price of the exchange-traded fund share. The target market for the exchange-traded fund is more likely to be individual traders rather than institutional traders.

To enable a futures exchange 501 to offer an options contract on the exchange-traded fund, the futures exchange 501 should periodically be in communication with data from the stock exchange 508 regarding the exchange-traded fund. The futures exchange 501 may refer to one or more separate futures exchanges. This implementation allows trader transactions 512 to occur, including the purchase, sale, and taking of positions in fund manager index futures contracts (and options thereon) and exchange-traded funds based on the fund manager index (and options thereon).

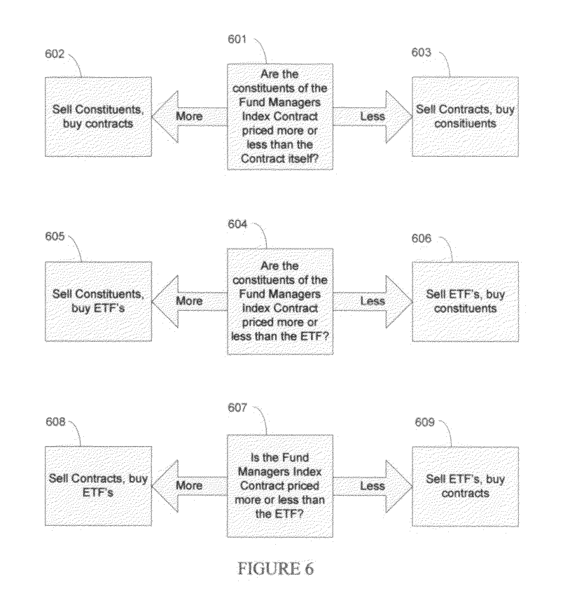

FIG. 6 depicts an example methodology for realizing an advantage of products that can be associated with a fund manager index. Many managers do not trade at their future price discounted at the risk-free interest rate (see discussion above regarding pricing of futures contracts). Examples of such managers can be those that make up the index 101 of FIG. 1 (first fund 102 (Fidelity Fund Futures in this example), second fund 103 (George Soros Quantum Fund Futures in this example), and third fund 104 (Barclays Commodity Trading Advisor Index in this example)). This creates an opportunity for profit by arbitrage. Put simply, arbitrage is the practice of taking advantage of a state of imbalance between two or more markets. A combination of matching deals is struck that capitalizes upon the imbalance, the profit being the difference between the market prices.

A simple example of arbitrage involves a stock on a stock exchange and its option on a futures exchange. When the price of a stock on the stock exchange and its corresponding futures contract on the options exchange are out of balance, one can buy the less expensive and sell the more expensive. Because the differences between the prices are likely to be small (and not last very long), this can only be done profitably with computers examining a large number of prices and automatically exercising a trade when the prices are far enough out of balance. Those with the fastest computers can take advantage of series of small differentials that would not be profitable if taken individually.

Existing methods of arbitrage between a fund managers-based index and its underlying components are even more difficult. For example, traders can purchase futures contracts or over-the-counter (OTC) derivatives based on Goldman Sachs's Commodity Index (GSCI). The GSCI represents the performance of about 25 fund managers from all commodity sectors—GSCI aims to provide commodity diversification.

The constituent fund managers can be spread across several commodity exchanges, and not all may lend themselves to arbitrage. Therefore, for a trader to arbitrage in the fund manager's market, the trader would purchase (or sell) a position in the GSCI, and proceed to individually sell (or purchase) its constituents across all of the several fund managers markets. Such a trader would likely lose opportunity for profit due to, for example, the transaction costs and time associated with purchasing and selling an array of constituents across an array of commodity exchanges, and the difficulty of identifying which of the constituents would best lend themselves to arbitrage (that is, the same problem associated with stock/option arbitrage, discussed above). Alternatively, a trader could purchase an OTC derivative of the GSCI; however, there are substantial disadvantages to such OTC transactions, including lack of market protection, no transaction guarantees, no clearinghouse, and no transparency.

The products associated with the index 101 of FIG. 1 overcome these drawbacks. Because the index 101 consists of comparatively small number of funds, the transaction time and costs are substantially reduced. Moreover, because the constituents of the index 101 represent both the source materials (first fund 102 (Fidelity Fund Futures in this example), second fund 103 (George Soros Quantum Fund Futures in this example), and third fund 104 (Barclays Commodity Trading Advisor Index in this example)) of a commercial process, the constituents lend themselves to profitable arbitrage. FIG. 6 depicts an example of a method for arbitraging with products based on the fund manager index 101 of FIG. 1. This process can be automated by a programmed computer configured to automatically execute appropriate trades.

In this example the trader owns two varieties of products associated with the fund manager index (exchange-traded funds and futures contracts), as well as the constituents of the fund manager index (for example, funds 102, 103, and 104 of FIG. 1). In one example, the query is, are the constitutes of the fund managers index contract priced more or less than the contract itself 601. In another example, the query is, are the constitutes of the fund managers index contract priced more or less than the exchange traded fund 604. In another example, the query is, is the fund manager's index contract priced more or less than the exchange traded fund 607.

Steps 601, 604 and 607 need not be performed in sequential order; in fact, they may be performed simultaneously. Moreover, the inquiries as to whether one investment or financial risk management product is priced “higher” than another does not necessarily refer to comparing the price of, for example, one fund manager index futures contract to one exchange-traded funds share, or the total of the constituents compared to one exchange-traded funds share; instead, the comparison can focus on the relative value of the investments. For example, in this example, comparing the price of ten fund manager index futures contracts to the total price of 3 first fund 102 (Fidelity Fund Futures in this example) contracts, 2 second fund 103 (George Soros Quantum Fund Futures in this example) contracts, and 1 third fund 104 (Barclays Commodity Trading Advisor Index in this example) contract.

At step 601, if the constituents are priced higher than the contract, then the trader takes a sell position in the constituents, and a buy position in the contract 602. If the contract is priced higher than the constituents, then the trader takes a sell position in the contract, and a buy position in the constituents 603. The trader may arbitrage by buying and selling in any proportion, and is not required to maintain a square position. In other words, a trader is not limited to buying ten 10 contracts and selling 3 first fund 102 (Fidelity Fund Futures in this example) contracts, 2second fund 103 (George Soros Quantum Fund Futures in this example) contracts, and 1third fund 104 (Barclays Commodity Trading Advisor Index in this example). Instead, a trader can take advantage of, for example, pronounced discrepancies in first fund 102 (Fidelity Fund Futures in this example) pricing by either buying or selling a greater proportion of first fund 102 (Fidelity Fund Futures in this example) contracts.

At step 604, if the constituents are priced higher than the exchange-traded fund, then the trader takes a sell position in the constituents, and a buy position in the exchange-traded fund 605. If the exchange-traded fund is priced higher than the constituents, then the trader takes a sell position in the exchange-traded fund, and a buy position in the constituents 606. The exchange-traded fund, because it is priced intra-day and may suffer from positive or negative tracking error, offers additional opportunities for arbitrage.

At step 607, if the fund manager index futures contract is priced higher than the exchange-traded fund, then the trader takes a sell position in the contract, and a buy position in the exchange-traded fund 608. If the exchange-traded fund is priced higher than the contract, then the trader takes a sell position in the exchange-traded fund, and a buy position in the contract 609. Again, because the exchange-traded fund it is priced intra-day and may suffer from tracking error, it offers additional opportunities for arbitrage.

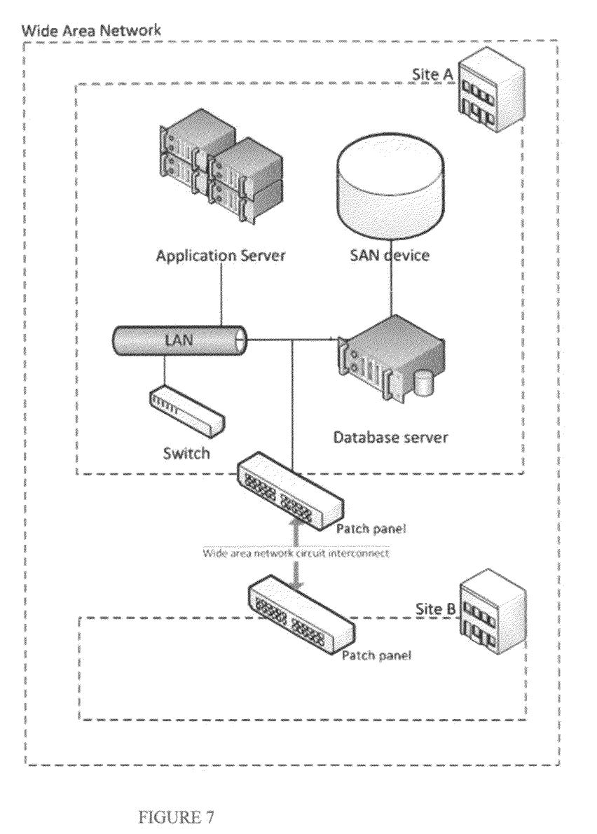

The components described above may be implemented as one or more computer software/logic programs/modules stored in a memory or computer storage device and executable by a computer processor to implement the disclosed functionality and process. The components described above may include a computer system and network. Referring to FIG. 7, a non-limiting example of a high level hardware that can used to implement the present invention is seen. The infrastructure should include but not be limited to: wide area network connectivity, local area network connectivity, appropriate network switches and routers, electrical power (backup power), storage area network hardware, server-class computing hardware, and an operating system such as for example Redhat Linux Enterprise AS Operating System available from Red Hat, Inc, 1801 Varsity Drive, Raleigh, N.C.

The clearing and settling and administrative applications software server can run for example on an HP ProLiant DL 360 G6 server with multiple Intel Xeon 5600 series processors with a processor base frequency of 3.33 GHz, up to 192 GB of RAM, 2 PCIE expansion slots, 1 GB or 10 GB network controllers, hot plug SFF SATA drives, and redundant power supplies, available from Hewlett-Packard, Inc, located at 3000 Hanover Street, Palo Alto, Calif. The database server can be run for example on a HP ProLiant DL 380 G6 server with multiple Intel Xeon 5600 series processors with a processor base frequency of 3.33 GHZ, up to 192 GB of RAM, 6 PCIE expansion slots, 16 SFF SATA drive bays, an integrated P410i integrated storage controller, and redundant power supply, available from Hewlett-Packard

Any suitable computer system having suitable processing, storage and communications capability may be used with the disclosed implementations, such as a mainframe computer, mini-computer, a workstation, a personal computer or a personal digital assistant. The disclosed implementations may be executed on a single computer system or one or more components may be executed on a computer system which is separate from one or more computer systems executing the remaining components, and suitably interconnected, such as via a network.

It should be understood that various changes and modifications preferred in to the embodiment described herein would be apparent to those skilled in the art. Such changes and modifications can be made without departing from the spirit and scope of the present invention and without demising its attendant advantages. It is therefore intended that such changes and modifications be covered by the appended claims.

What is claimed is:

1. A financial instruments comprising:
at least two open-ended funds having settlement prices;
a weighting factor assigned to the at least two open-ended funds;
a components value based on the settlement price and weighting factor;
a fund manager futures index based on the component values; and
a financial instrument based on the fund manager index.

2. The financial instrument of claim 1 further wherein the financial instrument comprises a futures contract.

3. The financial instrument of claim 2 further wherein the financial instrument comprises an option on the futures contract.

4. The financial instrument of claim 1 further wherein the financial instrument comprises an exchange-traded fund.

5. The financial instrument of claim 4 further wherein the financial instrument comprises an option on the exchange-traded fund.

6. The financial instrument of claim 1 further wherein the open-ended funds are selected from the group comprising mutual funds, hedge funds, an index of funds, a fund of funds, and combinations thereof.

7. The financial instrument of claim 1 further including creating a fund manager futures index that tracks the settlement prices of three open-ended funds.

8. The financial instrument of claim 7 further including assigning a weighting factor of one to the first open ended fund, two to the second open ended fund, and three to the third open ended fund.

9. The financial instrument of claim 7 further including creating a fund manager futures index that tracks the settlement prices of four open-ended funds.

10. A financial method comprising:
creating a fund manager futures index that tracks settlement prices of at least two open-ended funds;
assigning a weighting factor to the at least two open-ended funds;
determining components value based on the settlement price and weighting factor;
calculating an index value based on the component values; and
creating a financial instrument based on the fund manager index.

11. The financial method of claim 10 further including creating a futures contract based on the fund manager index.

12. The financial method of claim 11 further including creating an option on the futures contract.

13. The financial method of claim 10 further including creating an exchange-traded fund based on the fund manager index.

14. The financial method of claim 13 further including creating an option on the exchange-traded fund.

15. The financial method of claim 10 further including selecting the open ended fund from the group comprising mutual funds, hedge funds, an index of funds, a fund of funds, and combinations thereof.

16. A method for providing a financial product comprising:
receiving an index value relating to the settlement prices of at least two open-ended funds;
assigning a weighting factor to each of the open-ended funds;
purchasing each open-ended fund in a proportion substantially consistent with its weighting factor; and
offering an exchange-traded fund whose value substantially tracks the fund manager index value.

17. The method of claim 16 wherein including receiving an index value relating to the settlement prices of three open-ended funds.

18. The method of claim 17 wherein including assigning a weighting factor of one to the first fund, a weighting factor of two for the second fund, and a weighting factor of three for the third fund.

19. The method of claim 16 further comprising providing an options contract, traded on a futures exchange, based on the exchange-traded fund.
